(19) United States
(12) Patent Application Publication
(10) Pub. No.: US 2010/0126840 A1
(43) Pub. Date: May 27, 2010

(54) Woven Manually Operable Input Device

(75) Inventor: Stuart Mark Walkington, Hertfordshire (GB)

Correspondence Address: ARTHUR JACOB, 25 EAST SALEM STREET, P.O. BOX 686, HACKENSACK, NJ, 07602, US

(73) Assignee: PERATECH LIMITED, Brompton on Swale, Richmond (GB)

(21) Appl. No.: 12/513,037

(22) PCT Filed: Nov. 7, 2007
(86) PCT No.: PCT/GB07/04255

§ 371 Date: Jan. 26, 2010

(30) Foreign Application Priority Data
Nov. 8, 2006 (GB) 0622204.6

(51) Int. Cl. H01H 1/10; B23P 17/04

(52) U.S. Cl. 200/512; 29/592.1

(57) ABSTRACT

A manually operable sensor for providing control signals to an electronic device. A fabric has a length substantially longer than its width with insulating yarns and electrically conductive yarns included therein, such that the conductive yarns define three conductive tracks running the length of the fabric. The conductive tracks are configured to interface with an electronic device at a first end and, at a second end, an active region of the fabric forms part of a sensor assembly that is receptive to a manually applied pressure. The sensor comprises first and second conductive regions to which a first and a second conductive track are connected respectively, to apply an electric potential to each conductive region. A conductive path is formed between a connected conductive track and the third conductive track of said active region when manual pressure is applied to one of the conductive regions.

### BACKGROUND OF THE INVENTION

The present invention relates to a manually operable sensor for providing signals to an electronic device.

A manually operable position sensor is disclosed in U.S. Pat. No. 6,452,479, assigned to the present applicant. It is known for sensors of this type to communicate with electronic devices. In order to provide electrical communication between a sensor assembly and the electronic device, it is necessary to define tracks for electrical conduction. In known assemblies, these tracks are provided using electrically conductive tape surrounded by an insulating material. The tape itself is relatively expensive and, furthermore, costs are involved in terms of creating the assembly itself.

### BRIEF SUMMARY OF THE INVENTION

According to an aspect of the present invention, there is provided a manually operable sensor for providing control signals to an electronic device, comprising: fabric having a length substantially longer than its width with insulating yarns and electrically conductive yarns included therein, such that said conductive yarns define first, second and third conductive tracks running the length of said fabric; said conductive tracks are configured to interface with an electronic device; and, at a second end an active region of the fabric forms part of a sensor assembly that is receptive to a manually applied pressure; wherein said sensor assembly comprises: a first conductive region and a separate second conductive region; said first conductive track is connected to said first conductive region, to apply a first electric potential, said second conductive track is connected to said second conductive region, to apply a second electric potential, a conductive path is formed between said first conductive track and said third conductive track of said active region when manual pressure is applied to said first conductive region, and a conductive path is formed between said second conductive track and said third conductive track of said active region when manual pressure is applied to said second conductive region.

It should therefore be appreciated that the invention provides for relatively inexpensive transmission tracks. Furthermore, these tracks are included within the sensor itself thereby further facilitating construction. A sensor of this type is particularly suitable for switch control, as used for the control of electronic devices such as mobile phones and audio players.

The particular nature of the fabric may vary but in a preferred embodiment the fabric is produced by a weaving process in which the weft yarns are woven between warp yarns and the conducting yarns are included as part of the warp yarns.

According to a second aspect of the present invention, there is provided a method of constructing a manually operable sensor for providing control signals to an electronic device, comprising the steps of: weaving a fabric with electrically conducting warp yarns that define three conductive tracks that run the length of the fabric; connecting said conductive tracks at a first end to a connector for interfacing with an electronic device; and, at a second end forming a sensor assembly that is receptive to manually applied pressure over an active region of the fabric, the sensor assembly comprising a first conductive region and a separate second conductive region; connecting a first conductive track to said first conductive region, and connecting a second conductive track to said second conductive region.

### BRIEF DESCRIPTION OF THE SEVERAL VIEWS OF THE DRAWINGS

The invention will now be described by way of example only, with reference to the accompanying drawings, of which:

FIG. 1 illustrates an embodiment of a manually operable sensor;

FIG. 2 shows an example of an application for the sensor identified in FIG. 1;

FIG. 3 shows a sensor construction;

FIG. 4 shows an enhancement to the sensor construction of FIG. 3;

FIG. 5 illustrates additional sensor construction elements;

FIG. 6 illustrates further additional sensor construction elements; and

FIG. 7 illustrates a further sensor arrangement.

### WRITTEN DESCRIPTION OF THE BEST MODE FOR CARRYING OUT THE INVENTION

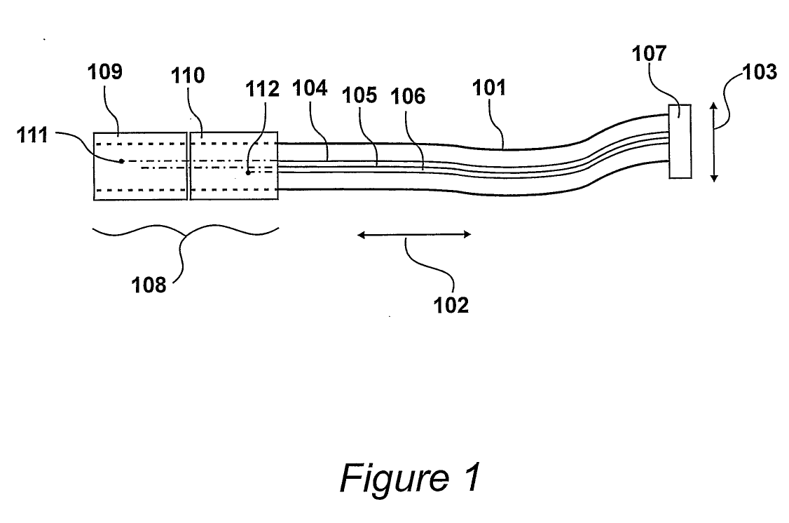

### FIG. 1

An embodiment of a manually operable sensor is illustrated in FIG. 1. A fabric strip or ribbon 101 has a length, illustrated by arrows 102, that is substantially longer than its width, illustrated by arrow 103. For example, the length of ribbon 101 may be typically seven hundred and fifty millimetres (750 mm) with a typical width of twenty-five millimetres (25 mm). The fabric has electrically insulating yarns and electrically conducting yarns included therein. The conducting yarns define three conductive tracks 104, 105 and 106 that are connected to an electrical connector 107. The electrical connector is provided to facilitate the interfacing of the sensor with an electronic device. At its opposite end, an active region 108 of the fabric forms part of a sensor assembly that is receptive to a manually applied pressure.

In a preferred sensor, the fabric is produced by a weaving process in which weft yarns are woven between warp yarns and the conducting yarns, that form tracks 104, 105 and 106, are included as part of the warp yarns. Thus, as the fabric is woven, it is produced in the direction indicated by arrow 102.

In a preferred embodiment, the conductive yarns are silver coated nylon and each conductive track 104 to 106 may have between five (5) and ten (10) conducting yarns, with seven (7) conducting yarns being present in a preferred embodiment. Multifilament conductive yarns or threads may be used in the construction of the sensor.

In a preferred embodiment, the spacing between the conductive tracks (the insulating portions) is such that it is greater than the width of the conducting tracks themselves. Preferably, the spacing is made consistent with readily available circuit connectors, such as circuit connector 107 that, typically, facilitates a spacing of two point five millimetres (2.5 mm). Thus, if alternate connections are selected, a spacing of five millimetres (5 mm) is achievable, as is preferred in the present embodiment.

In a preferred embodiment, active region 108 forms part of a sensor assembly providing discrete switches, in which the application of manual pressure is identified through detection of an electrical connection between two conductive tracks. The sensor assembly comprises a first conductive region 109 and a separate second conductive region 110. A first conductive track 104 may apply plus volts to a position 111 of the first conductive region 109. Similarly, second conductive track 105 may apply plus volts to a position 112 of the second conductive region 110. At a position where pressure is applied to the first conductive region, causing a mechanical interaction, a voltage is applied to conductive track 105, and at a position where pressure is applied to the second conductive region a voltage is also applied to conductive track 105 in response. Thus, the first and second conductive regions, in combination with the active region of the fabric, provide two discrete switches. The position of conductive regions may be emphasised by the provision of masking.

A function may be associated with each of the first and second conductive regions, such that by determining which of the first and second discrete switches has been manipulated, it is possible to determine the actual function that has been selected.

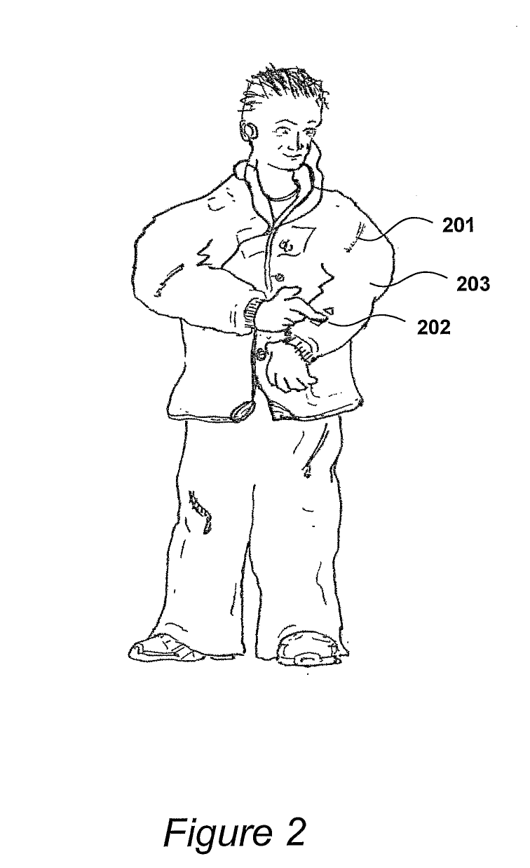

### FIG. 2

An example of an application for the sensor is shown in FIG. 2. In this example, the sensor is included in a jacket 201. A manually operable data input device 202, operating in accordance with the sensor technology of the preferred embodiment, is fabricated into an arm 203 of the jacket. The data input device is configured to receive input data from a user which, for example, may be used to control a warming panel within the jacket. Such a warming panel may include a battery-powered heat pad that contains textile wires and has adjustable temperature control. Thus, a control may be provided for on/off operation of the warming panel and another may be provided for adjusting the operating temperature of the warming panel.

Alternatively, the data input device may include commands for controlling a mobile device such as a radio device, a mobile telephone or an audio player, such as an MP3 player.

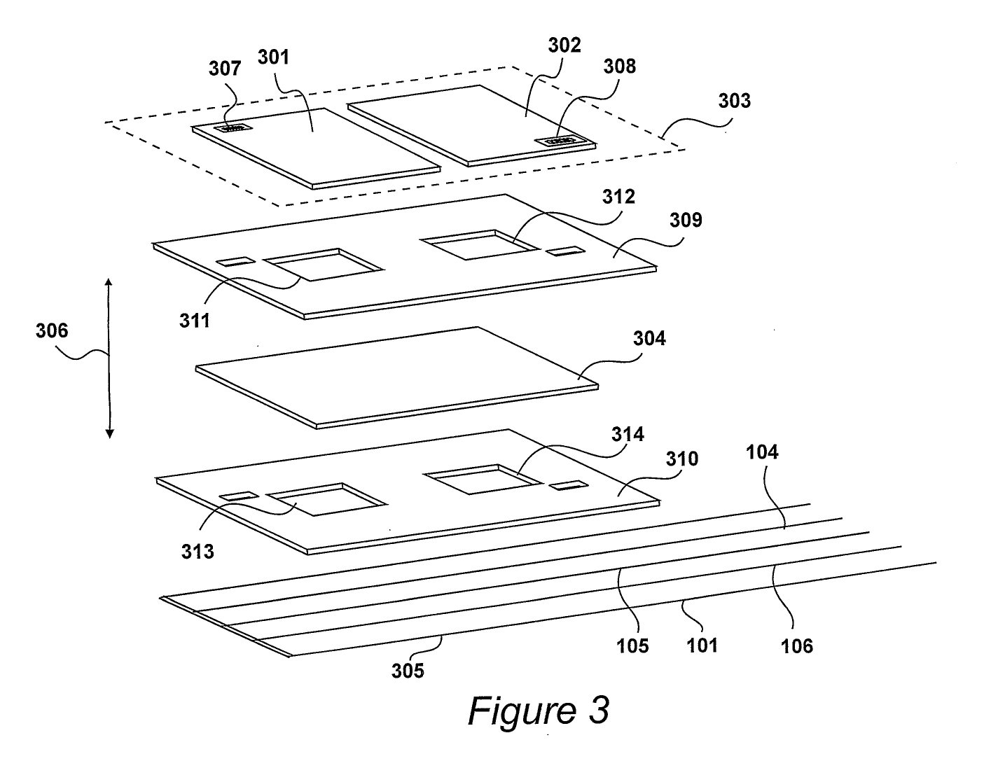

### FIG. 3

An example of a sensor construction is illustrated in FIG. 3. The sensor includes a first conductive region 301 and a separate second conductive region 302. In the shown example, the first and second conductive regions are independent components that are oriented in the same plane 303. In an alternative arrangement, both conductive regions are included in a conductive fabric layer in which they are insulated from one another. In the sensor assembly, a separation layer 304 is placed between the first and second conductive regions 301, 302 and an active region 305 of fabric 101.

In FIG. 3, an exploded view is presented but it will be appreciated that, in use, the individual layers are placed in contact. In addition, electrical conduction in the vertical direction, illustrated by arrow 306, is provided by stitching through the layers using conductive threads. Thus, by the provision of stitching, conductive track 104 is electrically connected to a corner 307 of conductive region 301. Similarly, conductive track 106 is electrically connected to a corner 308 of the second conductive region 302. Preferably, the conductive regions 301,302 are constructed from carbonised nylon.

Without pressure being applied, separation layer 302 prevents the conductive regions 301, 302 from being placed into electrical contact with the central third conductive track 105. However, when pressure is applied, separation layer 304 is compressed and as such electrical connection takes place at the position of the mechanical interaction, that is, where the pressure is applied.

To facilitate the detection of a mechanical interaction with a conductive region, masking means are provided. In the preferred embodiment, the masking means includes a first mask 309 and a second mask 310. The first mask 309 is located above the separation layer 304 and the second mask 310 is located below the separation layer. First mask 309 defines a first window 311 vertically aligned within first conductive region 301 and a second window 312 vertically aligned within second conductive region 302. Similarly, second mask 310 defines a third window 313 vertically aligned with first window 311 and a fourth window 314 vertically aligned with second window 312.

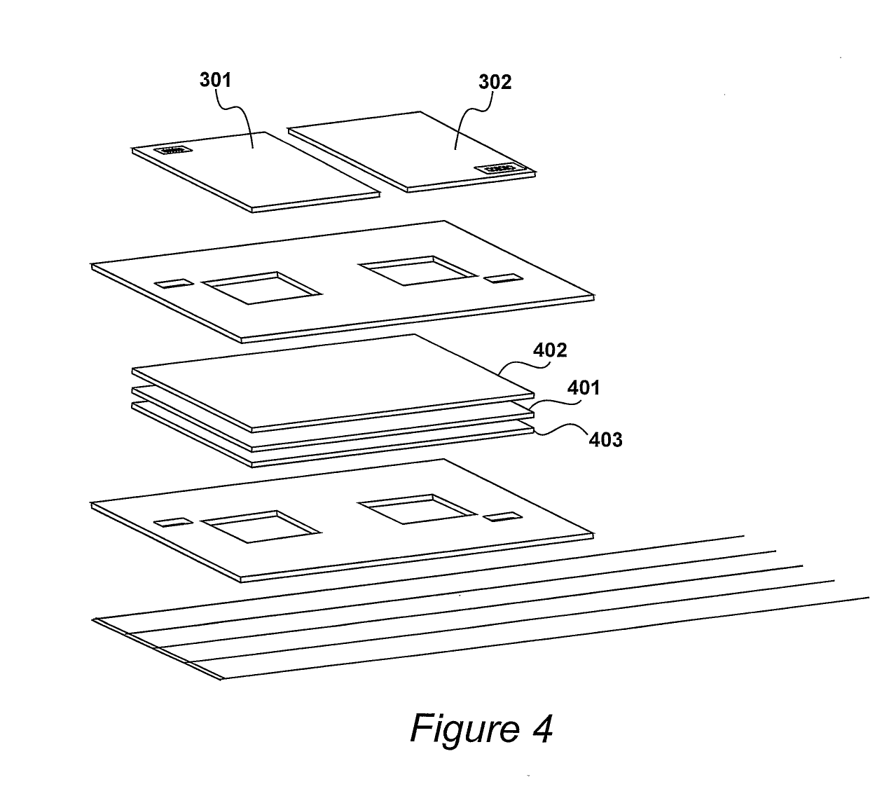

### FIG. 4

An enhanced embodiment is illustrated in FIG. 4 that deploys additional component layers similar to those disclosed in the aforesaid US patent assigned to the present applicant. In this preferred embodiment, the single separation layer 304 is replaced with three separate layers, a central layer 401 being conductive, while an upper layer 402 is an insulating separator layer and a lower layer 403 is also an insulating separator layer. In this configuration, conduction occurs when manual pressure is applied to a conductive region 301, 302. However, the provision of the additional layers prevents accidental triggering when, for example, the material is bent or folded. In addition, it will be appreciated that other technical solutions may be provided to give the functionality of the separation layer.

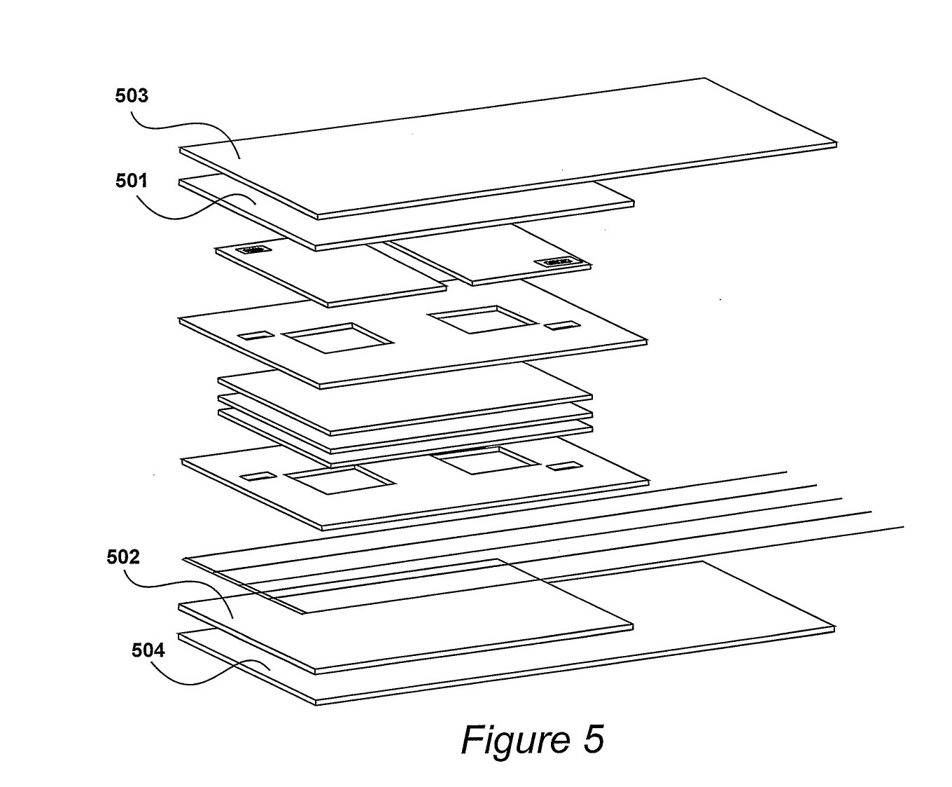

### FIG. 5

As illustrated in FIG. 5, an upper cover 501 is preferably provided, along with a lower cover 502, to protect the operation of the sensor in the active region. Furthermore, an upper waterproof cover 503 and a lower waterproof cover 504 are provided that run the length of the sensor from the active region to the electrical connector.

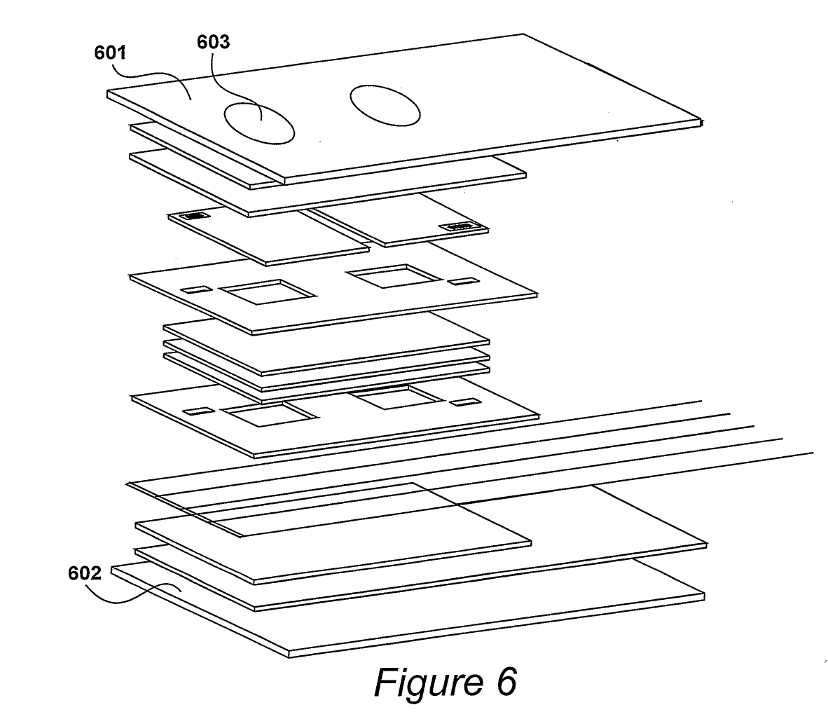

### FIG. 6

As illustrated in FIG. 6, further material is provided at 601 and 602 to facilitate the sewing of the sensor into a bag, jacket (as illustrated in FIG. 2) or other material environment so as to ensure robust operation. In addition, the upper cover 601 may include graphical representations, illustrated at 603, which relate to particular device functions. Thus, in the example shown in FIG. 2, in which the device is used to control a warming panel, these graphical representations relate to particular operations of a heat pad, such as on/off and operating temperature control.

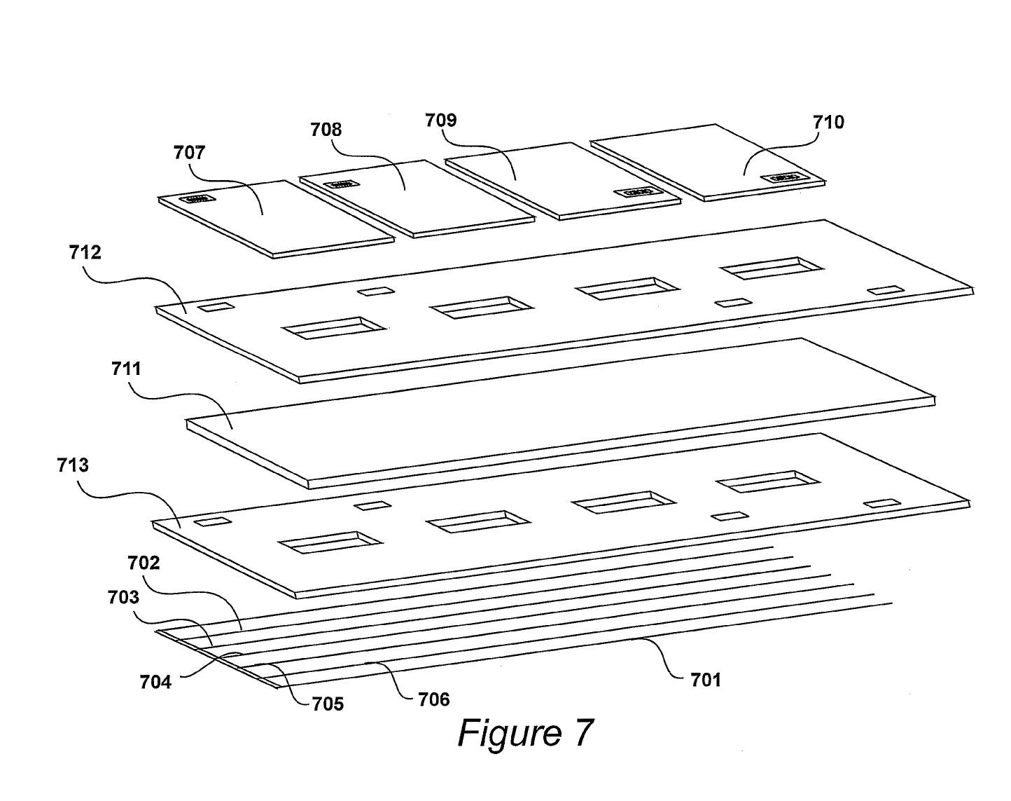

### FIG. 7

A further sensor arrangement is illustrated in FIG. 7. A fabric strip or ribbon 701 defines five conductive tracks 702, 703, 704, 705 and 706. The sensor assembly comprises four separate conductive regions 707, 708, 709 and 710. As shown, the sensor assembly further comprises a separation layer 711, a first mask layer 712 above the separation layer 711 and a second mask layer 713 below the separation layer 711.

Within the sensor assembly, conductive tracks 702, 703, 705 and 706 are respectively electrically connected to conductive regions 707, 708, 709 and 710 by conductive stitching, with central conductive track 704 remaining as the common track to which electrical connection is made during a mechanical interaction. The sensor hence provides four (4) discrete digital switches, being arranged such that a conductive path is established between conductive tracks 702 and 704, 703 and 704, 705 and 704 or 706 and 704 depending upon which conductive region manual pressure is applied. Thus, it can be understood that to provide a number X of switches, the number X+1 conductive tracks are required.

In summary, it will be appreciated that the switch sensor may be constructed by firstly weaving a fabric with electrically conducting warp yarns that define three conductive tracks that run the length of the fabric. An electrical connector is connected to the conductive tracks at a first end to facilitate the interfacing of the sensor with an electronic device. Then, at a second end, a sensor assembly is formed that is receptive to manually applied pressure over an active region of the fabric.

1. A manually operable sensor for providing control signals to an electronic device, comprising:
fabric having a length substantially longer than its width with insulating yarns and electrically conductive yarns included therein, such that said conductive yarns define first, second and third conductive tracks running the length of said fabric;
said conductive tracks are configured to interface with an electronic device; and, at a second end
an active region of the fabric forms part of a sensor assembly that is receptive to a manually applied pressure; wherein
said sensor assembly comprises:
a first conductive region and a separate second conductive region;
said first conductive track is connected to said first conductive region, to apply a first electric potential,
said second conductive track is connected to said second conductive region, to apply a second electric potential,
a conductive path is formed between said first conductive track and said third conductive track of said active region when manual pressure is applied to said first conductive region, and
a conductive path is formed between said second conductive track and said third conductive track of said active region when manual pressure is applied to said second conductive region.

2. A sensor according to claim 1, wherein said fabric is produced by a weaving process in which weft yarns are woven between warp yarns and the conductive yarns are included as part of the warp yarns.

3. A sensor according to claim 1, wherein the conductive yarns are silver coated nylon.

4. A sensor according to claim 2, wherein a conductive track is created from a plurality of conductive yarns.

5. A sensor according to claim 4, wherein each conductive track is created from between five and ten conductive yarns.

6. A sensor according to claim 1, wherein the insulating spacing between conductive tracks is wider that the width of the conductive tracks.

7. A sensor according to claim 6, wherein the spacing between conductive tracks is made consistent with readily available circuit connectors.

8. A sensor according to claim 7, wherein the spacing between conductive tracks is two point five millimetres.

9. A sensor according to claim 1, wherein said first conductive region and said separate second conductive region are included in a first conductive fabric layer, and a separation layer is disposed between said first conductive fabric layer and said active region of said fabric.

10. A sensor according to claim 1 including masking means for defining active locations at positions on said active region.

11. A sensor according to claim 10, wherein said masking means includes a first mask and a second mask, wherein said first mask is located above said separation layer and said second mask is located below said separation layer.

12. A sensor according to claim 10, including a cover sheet, wherein said cover sheet has graphical representations of device functions printed at respective positions of said active locations.

13. A sensor according to claim 9, wherein:
said separation layer includes a first insulating layer, a second conductive layer and a third insulating layer; and
both of said first and third insulating layers allow conduction therethrough when manual pressure is applied but at least one will prevent conduction under conditions of bending.

14. A sensor according to claim 13, wherein said first conductive layer and/or said second conductive layer include carbonised nylon.

15. A sensor according to claim 1, wherein said sensor is configured to be attached to a garment or a bag.

16. A method of constructing a manually operable sensor for providing control signals to an electronic device, comprising the steps of:
weaving a fabric with electrically conducting warp yarns that define three conductive tracks that run the length of the fabric;
connecting said conductive tracks at a first end to a connector for interfacing with an electronic device; and, at a second end
forming a sensor assembly that is receptive to manually applied pressure over an active region of the fabric, the sensor assembly comprising a first conductive region and a separate second conductive region;
connecting a first conductive track to said first conductive region, and
connecting a second conductive track to said second conductive region.

17. A method according to claim 16, wherein said first conductive region and said separate second conductive region are included in a first conductive fabric layer, and said method further comprises the steps of:
placing a separation layer over the woven fabric, and
placing said first conductive fabric layer over said separation layer.

18. A method according to claim 17, further comprising the step of applying masking for defining active locations at positions on said active region.
